(19) United States
(12) Patent Application Publication
(10) Pub. No.: US 2007/0177638 A1
(43) Pub. Date: Aug. 2, 2007

(54) Frequency-doubled solid state laser optically pumped by frequency-doubled external-cavity surface-emitting semiconductor laser

(76) Inventors: Wolf Seelert, Lubeck (DE); Andreas Diening, Lubeck (DE); Vasiliy Ostroumov, Bad Schwartau (DE)

Correspondence Address: STALLMAN & POLLOCK LLP, 353 SACRAMENTO STREET, SUITE 2200, SAN FRANCISCO, CA, 94111, US

(21) Appl. No.: 11/341,994

(22) Filed: Jan. 27, 2006

(51) Int. Cl. H01S 3/30; H01S 3/10

(52) U.S. Cl. 372/22; 372/5

(57) ABSTRACT

A laser-resonator includes a praseodymium-doped crystal gain-medium optically pumped by plane-polarized blue light delivered by a frequency-doubled, external cavity, surface-emitting semiconductor laser. The laser-resonator generates fundamental radiation at one of several possible wavelengths between about 500 nm and 750 nm. The fundamental wavelength generated is determined by a wavelength-selective element located in the laser-resonator and the polarization-orientation of the blue light relative to the c-axis of the crystal gain medium. An optically nonlinear crystal located in the laser-resonator frequency doubles the fundamental radiation to provide ultraviolet radiation.

### TECHNICAL FIELD OF THE INVENTION

The present invention relates in general to lasers delivering by ultraviolet radiation (UV) by frequency conversion of fundamental laser radiation having a wavelength in the visible or a longer-wavelength region of the electromagnetic spectrum. The invention relates in particular to semiconductor-laser pumped solid-state lasers delivering UV radiation by frequency-doubling fundamental radiation from a solid-state gain medium.

### DISCUSSION OF BACKGROUND ART

There a several laser applications that require relatively high average power, for example, greater than one-hundred milliwatts (mW) average power, of UV laser radiation at some UV wavelength between about 200 nanometers (nm) and 400 nm. Commercially available frequency-doubled argon-ion (gas) lasers can deliver CW power of about 100 milliwatts (mW) or greater at a wavelength of about 244 nm, or 400 mW in a multiline output with wavelengths between about 244 nm and 280 nm. Such lasers are useful in applications such as writing of optical fiber gratings, UV-Raman resonance spectroscopy and inspection of semiconductor manufacturing optics. These lasers unfortunately require a few kilowatts (kW) of three-phase electrical power and can weigh more than 200 pounds (lbs) including a power supply.

Improvements in solid-state lasers have made available Q-switched, pulsed intra-cavity frequency-tripled and intra-cavity frequency-quadrupled solid state lasers, with a neodymium-doped gain medium such as Nd:YAG or Nd:YVO₄, that are capable of delivering more than 2 Watts (W) of average power at wavelengths of 266 nm (frequency quadrupled) or 355 nm (frequency tripled), and at a pulse repetition rate between about 1 Hertz (Hz) and 100 KHz. Applications of these lasers include high-throughput via-hole drilling in printed circuit (PC) boards, fuel injector nozzle drilling, surface cleaning, integrated circuit (IC) singulation, and drilling, cutting and trenching hard materials, such as stainless steel, silicon, ceramics, diamond and sapphire. These lasers are more efficient than argon-ion based UV lasers, weigh less than 100 lbs including a power supply, and can be run from a normal single phase electrical supply with less than 1 kW of electrical consumption. IC-frequency tripling and quadrupling, however, are rather complex and require complex control technology to ensure that the laser output power and beam-pointing are stable.

One approach to avoiding the measures needed to stably operate an intra-cavity frequency-tripled or frequency-quadrupled laser would be to configure an intracavity doubled laser having a gain medium such as praseodymium-doped yttrium lithium fluoride (Pr:YLF) that can deliver a fundamental wavelength between about 500 nm and 750 nm. Within this wavelength range, Pr:YLF has transitions (gain-lines) at about 522 nm, about 644 nm, and about 720 nm among others. Fundamental wavelengths of 522 nm and 720 nm, when frequency doubled, would provide UV wavelengths of 261 nm and 360 nm respectively. Optical pump radiation for energizing these transitions of Pr:YLF would need to have a wavelength of between about 430 nm and 490 nm.

In a paper “Diode pumping of a continuous-wave Pr³⁺-doped LiYF₄ laser”, A. Richter et al., Optics Letters, vol. 29, no. 22, p. 2638-40, (15 Nov. 2004), optically pumping a 644 nm transition of Pr:YLF with a gallium nitride (GaN) diode-laser delivering radiation at 442 nm is described. Optical pumping of a Pr-doped host using aGaN, indium gallium arsenide (InGaN), indium gallium nitride arsenide (InGaNAs), or gallium nitride arsenide (GaNAs), diode-laser is also disclosed in U.S. Pat. No. 6,125,132 and in U.S. Pat. No. 6,490,349.

In order to achieve a frequency-doubled output in excess of 400 mW, an optical pump power of at least 1.6 W would be required. This would require combining the output of 30 or even more commercially-available GaN, InGaN, InGaNAs, or GaNAs diode-lasers, which would not be practical or efficient in a laser configured for commercial sale. At the present state of such diode-lasers, a pulsed mode of operation is preferred for providing high peak power. For Q-switched operation of a solid state laser, CW pump radiation is usually preferred. There is a need for an efficient compact arrangement for providing optical pump radiation for a frequency-doubled, solid-state laser delivering UV radiation. Preferably, the optical pump radiation should be CW radiation.

### SUMMARY OF THE INVENTION

In one aspect, apparatus in accordance with the present invention comprises a laser-resonator including a crystal gain-medium doped with at least praseodymium. An intra-cavity frequency-doubled OPS laser is arranged to generate and deliver light having a wavelength between about 420 nm and 500 nm to the praseodymium-doped crystal gain-medium for energizing the gain-medium. This optical pumping causes fundamental radiation having a wavelength between about 500 nm and 750 nm to circulate in the laser-resonator. The laser-resonator includes an optically nonlinear crystal arranged to frequency double the fundamental radiation thereby generating ultraviolet radiation having a wavelength between about 250 nm and 375 nm.

In one preferred embodiment of the apparatus, the gain medium is praseodymium-doped yttrium lithium fluoride (Pr³⁺:YLF) crystal. The light delivered by the intra-cavity frequency-doubled OPS laser is plane polarized, and the polarization orientation of the light is parallel to the c-axis of the Pr³⁺:YLF crystal. The ultraviolet radiation may have a wavelength of about 261 nm, about 272 nm, about 304 nm, about 322 nm, about 335 nm, about 346 nm, about 349 nm, about 350 nm, about 353 nm, about 354 nm, about 355 nm, and about 360 nm.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIG. 1 is a graph schematically illustrating absorption as a function of wavelength in a range between 420 nm and 500 nm for crystal Pr:YLF at polarization orientations parallel (π) and perpendicular (σ) to the crystal c-axis.

FIG. 2 is a graph schematically illustrating emission cross-section as a function of wavelength in a Pr³⁺:YLF crystal.

FIG. 3 is a graph schematically illustrating detail of relative strength of eight laser transitions of Pr:YLF in a wavelength range between about 660 and 730 nm for the two polarizations of FIG. 1

FIG. 4 schematically illustrates a preferred embodiment of a frequency doubled solid state laser in accordance with the present invention, optically pumped by two optically pumped semiconductor lasers.

### DETAILED DESCRIPTION OF THE INVENTION

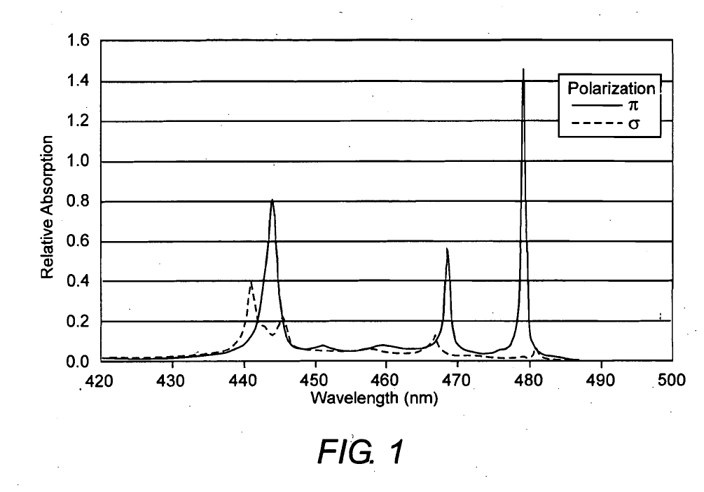

Referring now to the drawings, wherein like components are designated by like reference numerals, FIG. 1 is a graph schematically illustrating absorption as a function of wavelength in a range between 420 nm and 500 nm for crystal Pr³⁺:YLF. Pr³⁺:YLF has a polarization-dependent absorption spectrum including absorption peaks, for a polarization orientation parallel to the crystal c-axis (π polarization), at wavelengths of about 444 nm, about 468 nm, and about 479 nm, with weaker absorption peaks for polarization perpendicular to the c-axis (σ polarization) at about 440 nm, about 445 nm, about 451 nm, about 460 nm, and about 467 nm. A Pr³⁺:YLF crystal can be pumped at any of these wavelengths, however, the 479 nm-wavelength may be preferred as having the highest absorption coefficient. It is important to note, however, that, whichever wavelength is selected, the pump-light is most preferably plane polarized, and the crystal suitably oriented to the polarization plane of the pump-light. By way of example at a wavelength of about 479 nm absorption for π-polarized light is about two orders of magnitude greater than that for σ-polarized light. Delivering unpolarized light at this wavelength, or delivering plane-polarized light with the polarization plane thereof oriented at 45° to the c-axis, could result in wastage of up to 49% of the light not being absorbed by the gain medium and accordingly not contributing to energizing the gain-medium.

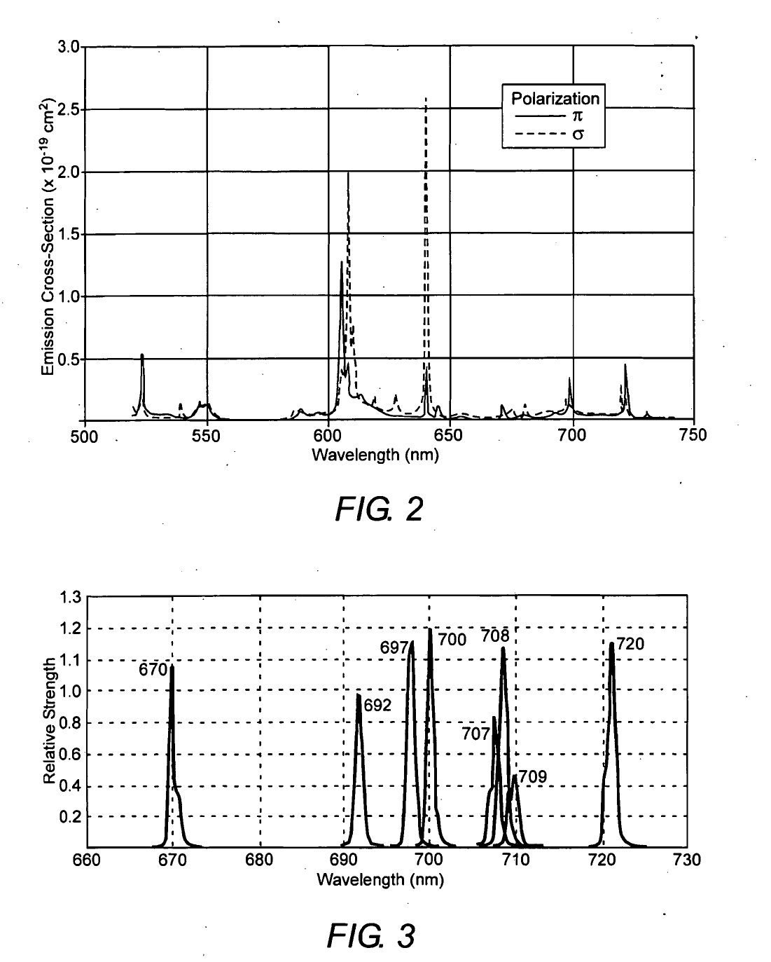

FIG. 2 is a graph schematically illustrating emission cross-section as a function of wavelength in a Pr³⁺:YLF crystal. Within this range, there are strong laser transitions at wavelengths of about 522 nm, about 545 nm, about 607 nm, about 644 nm, about 697 nm, and about 720 nm. In a wavelength region between 660 nm and 730 nm there are other useful, but less strong, transitions. FIG. 3 is a graph schematically illustrating detail of eight of these laser transitions of Pr³⁺:YLF in the range between 660 nm and 730 nm. This wavelength range is a range which can be designated “extended red” (ER). The transition wavelengths indicated in the graph of FIG. 3 are at about 670 nm, about 692 nm, about 697 nm, about 700 nm, about 707 nm, about 708 nm, about 709 nm, and about 720 nm.

In a laser in which any of the above-discussed transition wavelengths (fundamental wavelengths) is frequency doubled (wavelength halved) by an optically nonlinear crystal, the frequency doubled (second harmonic or 2H) wavelength will be in the UV region of the electromagnetic spectrum. The range of UV wavelengths possible will be between about 250 nm and 375 nm and include wavelengths of about 261 nm, about 272 nm, about 304 nm, about 322 nm, about 335 nm, about 346 nm, about 349 nm, about 350 nm, about 353 nm, about 354 nm, about 355 nm, and about 360 nm.

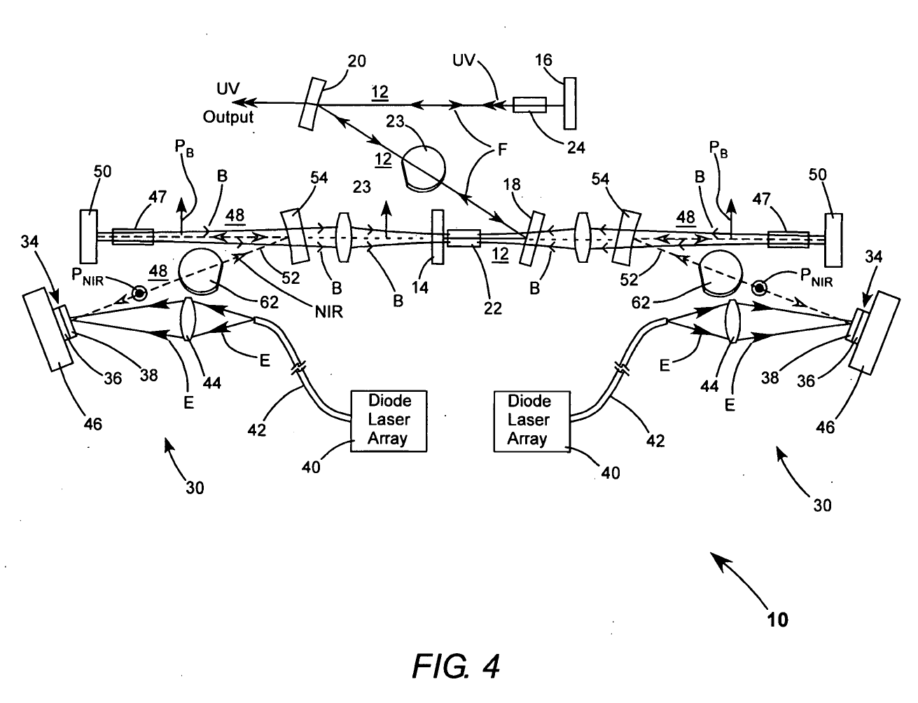

FIG. 4 schematically illustrates one preferred embodiment 10 of a frequency-doubled solid-state laser in accordance with the present invention configured specifically for use with a solid-state gain medium such as the above discussed Pr³⁺:YLF. Laser 10 includes a laser-resonator having a twice-folded (Z-folded) resonator 12 formed between mirrors 14 and 16. Resonator 12 is folded by fold mirrors 18 and 20. End mirrors 14 and 16 preferably all have maximum reflectivity, for example greater than 99.8% reflectivity, at whichever of the above discussed transition wavelengths is selected as the fundamental wavelength to be frequency doubled. End mirror 14, and fold mirrors 18 and 20, also have transmission requirements, and end mirror 16 has an additional reflection requirement. These additional transmission and reflection requirements are discussed further hereinbelow. A birefringent filter 23 is located in resonator 12 for selecting that one of the transition wavelengths of Pr³⁺:YLF wavelengths required as the fundamental wavelength to be frequency doubled.

A Pr³⁺:YLF crystal (gain medium) 22 is located between end-mirror 14 and fold-mirror 18 of resonator 12. The crystal is optically pumped at opposite ends thereof by pump-light B, which has one of the wavelengths discussed above with reference to FIG. 2. For this reason, end mirror 14 and fold mirror 18 in addition to having maximum reflectivity at the fundamental wavelength each have maximum transmission at whichever blue wavelength is selected for the optical pump light. A transmission of 90% or greater is usually possible in such mirrors. As a result of the optical pumping, fundamental radiation circulates in resonator 12 between end mirrors 14 and 16 thereof as indicated by arrows F.

An optically nonlinear crystal 24 is located between fold-mirror 20 and end-mirror 16. Suitable crystal materials include, but are not limited to, lithium borate (LBO), bismuth borate (BIBO), potassium niobate (KNbO₃), β-barium borate(BBO), cesium lithium borate (CLBO), and cesium borate (CBO), which may be cut for either type-I or type-II phase matching. Periodically poled crystals such as periodically poled lithium tantalate (PPLT) and periodically poled lithium niobate (PPLN) are also suitable. End-mirror 16, in addition to having maximum reflectivity at fundamental wavelength F, also has maximum reflectivity at the second-harmonic (UV) wavelength. Accordingly, UV radiation generated on a forward-pass of radiation F through crystal 24 is reflected from mirror 16 back through the crystal and is reinforced by UV radiation generated by a reverse pass of the fundamental radiation through the crystal. Fold mirror 20 in addition to having maximum reflectivity at the fundamental wavelength has maximum transmission at the UV wavelength. Accordingly, UV radiation is delivered from resonator 12 via mirror 20 as UV output radiation of the laser.

Optical pump light (designated by arrows E) for crystal 12 is supplied by two optically pumped, intracavity frequency-doubled, external cavity, surface-emitting semiconductor lasers 30. These are referred to hereinafter simply as frequency-doubled OPS lasers. Each frequency-doubled OPS laser 30 includes an optically pumped semiconductor (OPS) structure 34 including Bragg mirror structure 36 surmounted by a gain-structure 38. Gain-structure 38 includes active layers separated by half-wavelengths of the emission (fundamental) wavelength by one or more separator layers. The composition of the active layers is selected to provide a fundamental wavelength that can be frequency doubled to blue light having a wavelength between about 420 nm and 500 nm. By way of example, for active layers of an InₓGa₍₁₋ₓ₎As_{y}P_{(1-y)}, composition where 0≦×≦1 and 0≦y≦1, emission wavelengths between about 700 and 1100 nm can be achieved by selection of appropriate proportions for x and y. The fundamental wavelength selected should be twice the desired wavelength of the blue light. In one example of such a structure, active layers of InₓGa₍₁₋ₓ₎As can provide an emission (fundamental) wavelength of about 958 nm, which can be intra-cavity frequency doubled to provide an output wavelength of 479 nm. The peak emission wavelength is temperature tunable by about 0.2 nm per ° C. OPS-structures suitable for use in frequency-doubled OPS laser 30 are available from Coherent Tutcore OY, of Tampere, Finland.

OPS structure 34 is supported in thermal contact with a heat sink 46 and is located in a folded resonator 48 formed between a mirror 50 and Bragg mirror structure 36 of the OPS structure. The resonator is folded by a fold mirror 54. Bragg mirror structure 36 and mirror 50 each have maximum reflection at the emission wavelength of the gain-structure. Mirror 50 also has maximum reflectivity at the second-harmonic wavelength (half the emission wavelength). Fold mirror 54 has maximum reflection at the emission wavelength of the gain-structure and maximum transmission at the second-harmonic wavelength.

Gain structure 38 of the OPS structure is optically pumped by pump light E delivered from a diode-laser array 40 via an optical fiber bundle 42. The pump light is focused by a lens 44 onto the OPS structure. As a result of the optical pumping, fundamental radiation circulates in resonator 48 as indicated by arrows NIR. An optically nonlinear crystal 47, for example, an optically nonlinear crystal of a material selected from the above-mentioned group of optically nonlinear crystal materials, converts fundamental radiation NIR to second-harmonic radiation (indicated by arrows B) on forward and reverse passes through crystal 47. Crystal 47, here, is arranged for type-I phase matching. A birefringent filter 62 is located in resonator 48 and arranged to maintain the wavelength of fundamental radiation at a value for which optically nonlinear crystal 47 is phase-matched for optimum second-harmonic conversion. The second-harmonic radiation (blue light) generated by crystal 47 is delivered from resonator 48 via fold mirror 54.

Regarding polarization orientations in OPS lasers 30, the orientation of birefringent filter 62 causes fundamental radiation NIR to be plane-polarized with the electric vector perpendicular to the plane of the drawing, as indicated by arrowhead P_{NIR}. Blue pump-light generated by optically nonlinear crystal 47 is polarized with the electric vector perpendicular to that of the fundamental radiation, i.e., in the plane of the drawing, as indicated by arrow P_{B}. Pr³⁺:YLF crystal 22 should be oriented such that the crystal c-axis is correctly aligned parallel or perpendicular to P_{B} depending on the wavelength of the pump light, as indicated by the graph of FIG. 1.

Summarizing the operation of laser 10, pump-light from diode-laser array 40 generates near infrared (NIR) fundamental radiation in resonator 48 of frequency doubled OPS 30. The NIR is frequency doubled in OPS 30 to provide plane-polarized blue light B. Blue light B optically pumps Pr³⁺:YLF crystal 22 in laser-resonator 12 generating fundamental radiation F at some transition wavelength between about 500 and 750 nm. The fundamental radiation is frequency doubled to provide ultraviolet (UV) radiation. The UV radiation is delivered from resonator 12 as output radiation of laser 10. While this sequence of two optical pumping stages and two harmonic conversion stages my seem elaborate, it is estimated that about 5 W of total pump-light power from diode-laser arrays 40, can generate about 500 mW of blue light B for optically pumping Pr³⁺:YLF crystal 22. With this level of pumping of crystal 22, it is estimated that a UV power of 200 mW of CW UV light at a wavelength of 360 nm can be delivered from resonator 12. This is comparable with the average power of pulsed radiation delivered by commercially available frequency-tripled Nd:YAG or Nd:YVO₄ laser.

It should be noted that while the present invention is described above with reference to a laser apparatus including once-folded OPS laser-resonators and a twice folded, solid-state laser-resonator operating in a CW mode, those skilled in the art will recognize that other resonator forms for both the frequency-doubled OPS laser and the frequency-doubled solid-state laser may be used without departing from the spirit and scope of the present invention. By way of example, pulsed operation of the OPS and solid-state resonators is also within the scope of the present invention, as is CW operation of the OPS-resonators with Q-switched pulsed operation of the solid-state resonator. Further, while end-pumping of crystal 22 from both ends is described, crystal 22 may be pumped by one frequency-doubled OPS laser only at one end of the crystal. Crystal 22 may also be laterally pumped.

In the above presented description, crystal 22 is described as being a Pr³⁺:YLF (praseodymium-doped yttrium lithium fluoride) crystal. Crystal 22, however, may be a crystal of any other host material doped at least with trivalent praseodymium (Pr³⁺). Other preferred Pr³⁺-doped materials for crystal 22 include, but are not limited to, yttrium aluminum oxides (Pr³⁺:Y₃Al₅O₁₂ and Pr³⁺:YAlO₃), barium yttrium fluoride (Pr³⁺:BaY₂F₈), lanthanum fluoride (Pr³⁺:LaF₃), calcium tungstate (Pr³⁺:CaWO₄), strontium molybdate (Pr³⁺:SrMoO₄), yttrium silicate (Pr³⁺:Y₂ SiO₅), yttrium phosphate (Pr³⁺:YP₅O₁₄), lanthanum phosphate (Pr³⁺:LaP₅O₁₄), lutetium aluminum oxide (Pr³⁺:LuAlO₃), lanthanum chloride (Pr³⁺:LaCl₃), lanthanum bromide (Pr³⁺:LaBr₃). Crystals may also include at least one rare-earth dopants in addition to praseodymium. Such additional dopants include, but are not limited to, erbium (Er³⁺), holmium (Ho³⁺), dysprosium (Dy³⁺), europium (Eu³⁺), samarium (Sm³⁺), promethium (Pm³⁺), and neodymium (Nd³⁺) and ytterbium (Yb³⁺).

In summary, the present invention is described above in terms of a preferred and other embodiments. The invention is not limited, however, to the embodiments described and depicted. Rather, the invention is limited only by the claims appended hereto.

1. Laser apparatus, comprising:
a laser-resonator including a crystal gain-medium doped with at least praseodymium;
an intra-cavity frequency-doubled OPS laser arranged to generate and deliver light having a wavelength between about 430 nm and 490 nm to said praseodymium-doped crystal gain-medium for energizing said gain medium and causing fundamental radiation having a wavelength between about 500 mn and 750 nm to circulate in said laser-resonator; and
wherein said laser-resonator includes an optically nonlinear crystal arranged to frequency double said fundamental radiation thereby generating ultraviolet radiation having a wavelength between about 250 nm and 375 nm.

2. The apparatus of claim 1, wherein the light delivered by said intra-cavity frequency-doubled OPS laser is plane polarized.

3. The apparatus of claim 2, wherein the polarization plane of the plane-polarized light delivered by said intra-cavity frequency-doubled OPS laser is oriented parallel to a crystal axis of said praseodymium-doped crystal gain-medium.

4. The apparatus of claim 3, wherein said praseodymium-doped crystal gain-medium is praseodymium-doped yttrium lithium fluoride and said crystal-axis is the crystal c-axis.

5. The apparatus of claim 4, wherein the light delivered by said intra-cavity frequency-doubled OPS laser has a wavelength in the group of wavelengths consisting of about 444 nm, about 468 nm, and about 479 nm.

6. The apparatus of claim 5, wherein the light delivered by said intra-cavity frequency-doubled OPS laser has a wavelength of about 479 mn.

7. The apparatus of claim 2, wherein the polarization plane of the plane-polarized light delivered by said intra-cavity frequency-doubled OPS laser is oriented perpendicular to a crystal axis of said praseodymium-doped crystal gain-medium.

8. The apparatus of claim 7, wherein said praseodymium-doped crystal gain-medium is praseodymium-doped yttrium lithium fluoride and said crystal-axis is the crystal c-axis.

9. The apparatus of claim 1, wherein the light delivered by said intra-cavity frequency-doubled OPS laser is plane polarized has a wavelength in the group of wavelengths consisting of about 440 nm, about 445 nm, about 451 nm, about 460 nm, and about 467 nm.

10. The apparatus of claim 1, wherein said ultraviolet radiation has a wavelength in the group of wavelengths consisting of about 261 nm, about 272 nm, about 304 nm, about 322 run, about 335 nm, about 346 nm, about 349 nm, about 350 nm, about 353 nm, about 354 nm, about 355 nm, and about 360 nm.

11. The apparatus of claim 1, wherein the material of said crystal gain medium is selected from the group of materials consisting of yttrium aluminum oxides, yttrium lithium fluoride, barium yttrium fluoride, lanthanum fluoride, calcium tungstate, strontium molybdate, yttrium silicate, yttrium phosphate, lanthanum phosphate, lutetium aluminum oxide, lanthanum chloride, lanthanum bromide.

12. The apparatus of claim 10, wherein said crystal gain medium is yttrium lithium fluoride.

13. The apparatus of claim 1, wherein said crystal gain medium is co-doped with at least one of erbium, holmium, dysprosium, europium, samarium, promethium, neodymium, and ytterbium.

14. The apparatus of claim 1, wherein said optically nonlinear crystal is a crystal of a material selected from the group consisting of lithium borate, bismuth borate, potassium niobate, β-barium borate, cesium lithium borate and cesium borate (CBO).

15. The apparatus of claim 1, wherein said optically nonlinear crystal is a periodically poled crystal.

16. The apparatus of claim 15, wherein said periodically poled crystal is one of periodically poled lithium tantalite and periodically poled lithium niobate.

17. Laser apparatus, comprising:
a laser-resonator including a crystal gain-medium doped with at least praseodymium, said crystal gain medium having first and second opposite ends;
first and second intra-cavity frequency-doubled OPS lasers, each thereof arranged to generate and deliver light having a wavelength between about 430 nm and 490 nm;
an optical arrangement for delivering light from said first intra-cavity frequency-doubled OPS lasers praseodymium into said crystal gain-medium via said first end thereof and an optical arrangement for delivering light from said second intra-cavity frequency-doubled OPS lasers praseodymium into said crystal gain-medium via said second end thereof, said light delivered from said intra-cavity frequency-doubled OPS-lasers for energizing said gain medium and causing fundamental radiation having a wavelength between about 500 nm and 750 nm to circulate in said laser-resonator; and
wherein said laser-resonator includes an optically nonlinear crystal arranged to frequency double said fundamental radiation thereby generating ultraviolet radiation having a wavelength between about 250 nm and 375 nm.

18. The apparatus of claim 17, wherein the light delivered by said intra-cavity frequency-doubled OPS lasers is plane polarized.

19. The apparatus of claim 18, wherein the polarization plane of the plane-polarized light delivered by said intra-cavity frequency-doubled OPS lasers is oriented parallel to a crystal axis of said praseodymium-doped crystal gain-medium.

20. The apparatus of claim 19, wherein said praseodymium-doped crystal gain-medium is praseodymium-doped yttrium lithium fluoride and said crystal-axis is the crystal c-axis.

21. The apparatus of claim 20, wherein the light delivered by said intra-cavity frequency-doubled OPS laser has a wavelength in the group of wavelengths consisting of about 444 nm, about 468 nm, and about 479 nm.

22. The apparatus of claim 21, wherein the light delivered by said intra-cavity frequency-doubled OPS laser has a wavelength of about 479 nm.

23. The apparatus of claim 22, wherein said ultraviolet radiation has a wavelength in the group of wavelengths consisting of about 261 nm, about 272 nm, about 304 nm, about 322 nm, about 335 nm, about 346 nm, about 349 nm, about 350 nm, about 353 nm, about 354 nm, about 355 nm, and about 360 nm.

24. A method of generating UV radiation comprising:
optically pumping a solid state laser, said solid state laser including a crystal gain-medium doped with at least praseodymium and wherein said solid state laser includes an intracavity optically nonlinear crystal arranged to frequency double said fundamental radiation and wherein said optically pumping step is performed with radiation from an intra-cavity frequency-doubled OPS laser arranged to generate and deliver light having a wavelength between about 430 nm and 490 nm to said praseodymium-doped crystal gain-medium for energizing said gain medium and causing fundamental radiation having a wavelength between about 500 nm and 750 nm to circulate in said laser-resonator and wherein said fundamental radiation is doubled thereby generating ultraviolet radiation having a wavelength between about 250 nm and 375 nm.

25. A method as recited in claim 24, wherein the radiation delivered by said intra-cavity frequency-doubled OPS laser is plane polarized.

26. A method as recited in claim 24, wherein said praseodymium-doped crystal gain-medium is praseodymium-doped yttrium lithium fluoride and said crystal-axis is the crystal c-axis.
